(19) United States
(12) Patent Application Publication
(10) Pub. No.: US 2024/0296379 A1
(43) Pub. Date: Sep. 5, 2024

(54) UNIVERSAL ADAPTER FOR LOW-OVERHEAD INTEGRATION OF MACHINE LEARNING MODELS WITH A WEB-BASED SERVICE PLATFORM

(71) Applicant: Microsoft Technology Licensing, LLC, Redmond, WA (US)

(72) Inventors: Sumit MANCHANDA, Kirkland, WA (US); Serena LEKHRAJANI, Atlanta, GA (US); Ankit CHOUDHARI, Bothell, WA (US); Masroor Hussain SYED, Bothell, WA (US)

(21) Appl. No.: 18/177,547

(22) Filed: Mar. 2, 2023

(51) Int. Cl. G06N 20/00; G06F 9/54; H04L 9/40

(52) U.S. Cl. CPC G06N 20/00; G06F 9/541; H04L 63/08

(57) ABSTRACT

A universal adapter provides low-overhead integration of machine learning (ML) models with a web-based service platform. The universal adapter receives a set of inputs associated with detection of a trigger event and accesses a configuration table to identify an ML model defined in association with execution trigger criteria satisfied by the set of inputs. The universal adapter retrieves, from the configuration table, a data contract for the ML model and constructs a call to the ML model using the data contract and the set of inputs associated with the trigger event. The universal adapter translates output received from the ML model to a unified object consumable by web-based service platform and provides the unified object to the web-based service platform.

### BACKGROUND

Various web-based platforms execute machine learning (ML) models behind-the-scenes to enhance and/or improve user interactions with the platform. Notably, some web-based platforms employ multiple different ML models for different purposes, such as to generate different customer insights and/or different types of content. For example, an online product sales website may execute one ML model to identify “similar products” to those that a customer has recently viewed or purchased and while concurrently executing another different ML model to identify “complementary products” to recommend to a user, such as hiking shoes when a user is searching for hiking socks. Likewise, a real estate website may utilize an ML model to determine whether a home is a “hot” home (e.g., highly desired/likely to sell quickly) or to generate a listing price point for the home, and a software-as-a-service (SAAS) company (e.g., ServiceNow) may utilize various other ML models to generate content that may enhance the user experience in still other ways, such as by presenting more relevant data to the customer or by generating content that otherwise simplifies the user's experience when interacting with the service.

Rolling out a new ML model is a non-trivial development task. Even after the model is built, weeks of additional development time are invested in writing code that serves to integrate the ML model with the existing web-based service platform. For example, code is written to automatically identify which types of events are to be processed by the new ML model and to translate model outputs into meaningful data that can be consumed by the existing platform and/or pushed to a user interface (UI). The complexity of integrating ML models into an existing web-based service platform is complicated by the fact that different models accept inputs of diverse forms and generate outputs of diverse forms.

### SUMMARY

According to one implementation, a universal machine learning (ML) model adapter receives, from a web-based service platform, a set of inputs associated with detection of a trigger event. The universal ML model adapter identifies, from a configuration table, an ML model that has execution trigger criteria satisfied by the set of inputs and retrieves, from the configuration table, a data contract for the ML model. Based on the data contract, the ML model adapter constructs a call to the ML model with input parameter values associated with the trigger event. In response to receiving output from the ML model, the universal ML model adapter translates the output to a unified object consumable by the web-based service platform and provides the unified object to the web-based service platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system including a universal ML model adapter that couples a web-based service platform to multiple different machine learning models.

FIG. 2 illustrates another example system including a universal ML model adapter that couples a web-based service platform to multiple different machine learning models.

FIG. 3 illustrates example operations for utilizing a universal ML model adapter to support bidirectional data flows between interfaces of a web-based service platform and multiple ML models in real-time without incurring overhead to integrate each newly-selected model into the existing platform.

FIG. 4 illustrates an example schematic of a processing device 400 suitable for implementing aspects of the disclosed technology.

### DETAILED DESCRIPTION

The herein disclosed technology provides a software component that serves as a universal adapter to couple a user interface (UI) of an existing web-based service platform to multiple machine learning (ML) models. In one implementation, execution of each of the ML models is selectively triggered by events captured within the UI, and outputs of the ML models are rendered to the same UI (or another UI of the web-based service platform) in real-time. New models can be easily added to the system by way of a simple update to a configuration table and without developing new code to integrate each new model into the system. This saves the extensive development time otherwise spent developing code to “pick up events” that are to be processed by the new model, formatting the event data for input to the new model, and translating outputs from the new model into a meaningful format that a user can view and interpret on a UI. In some systems, the model integration time saved is on the order of multiple months (e.g., 12-14 weeks) for each newly integrated model.

In addition to development time saving, the disclosed technology advantageously increases the feasibility of performing what is known as “A/B testing” (e.g., side-by-side, in-the-field testing) of new models to determine which model performs the best and is the best candidate for long-term use. For example, two models may promise the same functionality but, when tested, provide results with varying degrees of accuracy. In the absence of the herein disclosed technology, weeks of development time are devoted to integrating each individual model before any testing can begin. This excessive overhead serves as a strong deterrent to performing A/B testing, ultimately motivating web-based platforms to “pick and choose” which ML models to integrate without testing alternative functionally-similar solutions. This lack of testing feasibility in existing systems often results in scenarios where significant overhead is invested into integrating a model that, once integrated, does not perform as well as expected.

According to one implementation, the disclosed technology includes a universal ML model adapter that receives inputs related to defined trigger events detected within the web-based platform, such as detection of particular user actions or other events associated with a user account. For each defined trigger event, the universal ML model adapter identifies a subset of available models “interested in” the trigger event, such as based on the type of trigger event or user data associated with the trigger event. The universal ML model adapter discovers a form of inputs expected by each of the identified models as well as other relevant information for invoking each model, such as a URL where the model can be reached and authentication information for communicating with the URL. The universal ML model adapter automatically executes each of the identified ML models interested in a given trigger event, providing each of the models with inputs of a requisite form (e.g., unique to each model). The universal ML model adapter receives the output from each of the ML models and translates the output from each ML model into an object of uniform form, referred to herein as a “unified object,” that is consumable by the web-service platform in the sense that the web-service platform is pre-configured to interpret the unified object and render information stored within the unified object to a user interface.

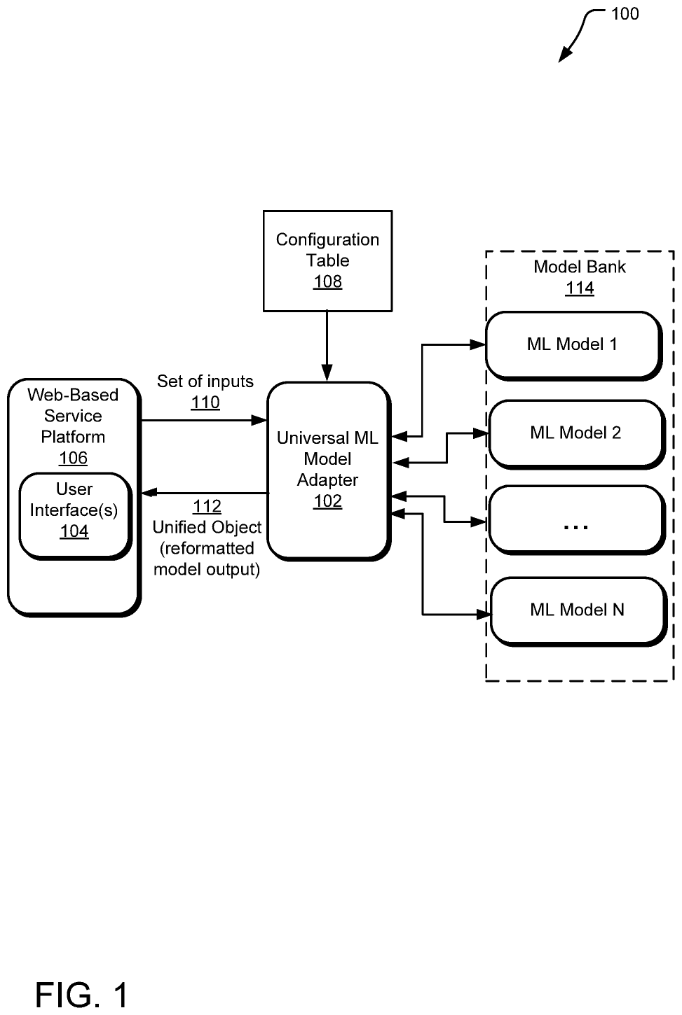

FIG. 1 illustrates an example system 100 that uses a universal ML model adapter 102 to couple a web-based service platform 106 to multiple different machine learning models (ML Model 1, ML model 2. . . . ML model N). FIG. 1 uses the nomenclature “model bank 114” to refer to the group of ML models utilized by the web-based service platform 106. This term is not intended to convey restriction or limitation on the physical location of each ML model or the enterprise that owns the model. For example, various ML models within the model bank 114 can be developed, owned, and hosted by the web-based service platform 106 and/or hosted by third-parties without affiliation to the web-based service platform 106. The various models in the ML model in the model bank 114 may be generated based on respective training datasets using any known supervised or unsupervised training technique.

The web-based service platform 106 can be any web-based service platform that provides a user interface to receive and process user inputs. In one implementation, the web-based service platform 106 is managed by a line-of-business (LOB) service that sells products online and/or that provides online services, such as Amazon®, Redfin®, ServiceNow®, or the like. In still another implementation, the web-based service platform 106 is a web-hosted ticketing system that users interact with the create help support tickets relating to a technical issues (e.g., hardware/software-related issues) experienced within the web-based service platform. In still other implementations, the web-based service platform 106 is a primarily non-commercial platform, such a platform designed for educational and/or research purposes.

A user (not shown) interacts with content served by the web-based service platform 106 through a user interface. Notably, FIG. 1 identifies user interface(s) 104 to signify that the web-based service platform 106 may support a variety of different user interfaces. As is noted below, some implementations of the universal ML model adapter 102 are designed to support a bidirectional flow of data between a single user interface and multiple ML models. For example, a user provides inputs through a UI that trigger model execution and the models return outputs that are rendered to the UI in real-time. In other implementations, a first UI provides the inputs that trigger execution of a model, and the model returns output that is rendered to a different UI within the web-based service platform 106.

In one implementation where the web-based service platform 106 is a product or service LOB, the UI 104 is used to browse product and/or service offerings, purchase products or services, etc. In the above example where the web-based service platform 106 is a ticketing system implemented to streamline technical support in relation to the web-based service platform 106, users interact with the user interface 104 to generate help support tickets that are directed, by the web-based service platform 106, to appropriate divisions or service teams within an enterprise.

The web-based service platform 106 defines one or more types of events that are to be automatically provided as inputs to the universal ML model adapter 102 and, in turn, potentially trigger execution of one or more of the ML models. In different implementations, a defined trigger event assumes a variety of forms. In some systems, ML model execution is trigger by a singular type of event. For example, in the above-described ticketing system, a user's submission of a help support ticket to the web-based service platform 106 serves as a defined trigger event. In other implementations, the web-based service platform 106 may define one or multiple different type(s) of trigger events to provide to the universal ML model adapter 102.

For example, a product sales platform defines a first type of trigger event that is detected when a user submits a search query and a second type of trigger event that is detected when a user clicks on a virtual shopping cart. Here, the first type of trigger event may serve to trigger execution of an ML model that identifies products similar to what a user has searched for (e.g., to recommend within search results) while the detected click on the virtual shopping cart triggers execution of an ML model that identifies products “frequently purchased with” those that are currently in the user's shopping cart.

In the above examples, the trigger events defined by the web-based service platform 106 include specific user interactions with one of the user interface(s) 104. In other implementations, the defined trigger events are not necessarily predicated based on user action. For example, the web-based service platform 106 may be an email client that defines a trigger event as occurring whenever an email is received satisfying in an inbox satisfies particular criteria (e.g., the email is from a defined sender, includes defined term(s) of interest). In some implementations, the web-based service platform 106 provides the user with configuration options that allow the user to self-select and/or configure characteristics of events that trigger execution of select, available ML models in the model bank 114.

When a defined trigger event is detected by the web-based service platform 106, the web-based service platform 106 provides a set of inputs 110 associated with the trigger event to the universal ML model adapter 102. In one implementation, the set of inputs 110 includes the specific data fields usable to provide the types of input parameters accepted by each of the various models in the model bank 114. In another implementation, the set of inputs 110 includes information that is useable by the universal ML model adapter 102 to self-acquire the unique types of parameters that each of the different models accepts as input. For example, the set of inputs 110 may include a user account number (e.g., tenant identifier) that the universal ML model adapter 102 uses to look up and retrieve additional user data for a particular user, such as account history (e.g., past purchases, interactions), profile information, system configuration information, logfile(s) residing on the user's machine or other database, etc. In an implementation where the web-based service platform 106 defines different types of trigger events, the set of inputs 110 may also identify the trigger event type, such as whether the event was triggered by submission of a user query, a shopping cart click, an incoming email, or a help ticket submitted by a customer. In addition to or in lieu of any of the above information, the set of inputs 110 may further include a unique identifier (e.g., event or ticket identifier) and/or a description of the event (e.g., a title describing the event type). In cases where the event is triggered by an email or other content received by the user, the email or other content may be included within the set of inputs 110.

Upon receipt of each set of inputs 110 passed to the universal ML model adapter 102, the universal ML model adapter 102 references a configuration table 108 and, from the configuration table 108, identifies a subset of the ML models in the model bank 114 that have execution trigger criteria satisfied by the trigger event type other information included within the set of inputs 110.

Execution trigger criteria may be based on the type of trigger event (e.g., a shopping cart click verses a user search query) or additionally and/or alternatively, based on characteristics of other user data associated with the trigger event. For example, one ML model may have execution trigger criteria satisfied when the user has submitted a query with search terms identifying produce items (e.g., to generate statistical data on the types of foods that users consume). In the case, the search terms of the user query may be included within the set of inputs 110 or otherwise readily retrievable by the universal ML model adapter 102 from other information (e.g., user account ID) that is included within the set of inputs 110.

In the example where the web-based service platform is a ticketing system, the different ML models in the model bank 114 may have execution trigger criteria satisfied by the inclusion of certain content within the user-submitted help ticket (e.g., category of reported problem, specific terms in written description of problem). Here, the ticket may itself be included within the set of inputs 110 or retrievable from a database based on an identifier and/or other information included within the set of inputs 110.

In still a further example, one or more of the ML models in the model bank 114 have execution trigger criteria that depends upon the location of the user associated with the trigger event. For example, one ML model is called when the user's IP address is in the U.S. and another ML model is called when the user's IP address is in Asia.

Based on the different execution trigger criteria that is identified in the configuration table 108 for each of the ML models in the model bank 114, the universal ML model adapter identifies a subset of models within the model bank 114 that are effectively “interested in” the trigger event in the sense that the model's execution trigger criteria are satisfied by the set of inputs 110 received in association with the trigger event. For ease of reference, these models are referred to as “interested models” in the following description.

Following identification of the interested models, the universal ML model adapter 102 again accesses the configuration table 108 and acquires a data contract for each of the interested models and mapping information that is usable to translate outputs of each of the ML models to a unified object that is consumable by the web-based service platform 106 and/or the various user interface(s) 104 of the web-based service platform 106. As user herein, a data object is said to be “consumable” by a body of code when that code is configured to detect (e.g., self-ingest), interpret, and render that object to the user interface.

The data contract retrieved from the configuration table defines the format of inputs expected by the associated ML model and the format of outputs generated by the associated ML model.

Using the data contract(s) retrieved from the configuration table 108, the universal ML model adapter 102 constructs and places an execution call to each of the interested ML models. Each different execution call includes input parameters of type and format as defined in the retrieved data contract for the associated model. In one implementation, the universal ML model adapter 102 generates the execution call for a given model exclusively based on data included in the set of inputs 110 passed to the universal ML model adapter 102 in response to detection of the corresponding trigger event. In another implementation, the universal ML model adapter 102 retrieves some information included in the execution call for a particular model from source(s) external to the set of inputs 110. For example, the set of inputs includes user account information and the universal ML model adapter 102 is configured to use the user account information to access a corresponding user account and retrieve information from the account that is defined, within the data contract of the ML model, as needed to construct a particular input parameter of the ML model.

Placing the execution call to each of the interested models may, in some implementations, entail passing authentication information (e.g., a token) to a URL. In these scenarios, the URL and authentication parameters needed to generate an authentication token are defined initially (e.g., by a developer) within the configuration table 108 in association with the ML model reachable through the URL.

The universal ML model adapter 102 retrieves the stored authentication parameters and URL from the configuration table 108, generates an authentication token in real-time using the authentication parameters, and transmits the authentication token to the URL prior to or concurrent with a call to invoke the ML model.

Outputs of each of the interested models are returned to the universal model adapter 102. Using the information in the associated data contract and the associated mapping information retrieved from the configuration table 108, the universal ML model adapter 102 transforms the format of outputs received of each model into that of a unified object 112 that the web-based service platform 106 and/or user interface 108 is configured to consume (e.g., interpret and self-render to a user interface). Regardless of the format of outputs received from the different models, each created uniform object is of a same, consistent form. The unified object 112 containing the output data of each individual one of the interested models is then returned to the web-based service platform 106 and information within the unified object is automatically presented to one of the user interfaces 104.

Depending on the use case, the model outputs are either rendered to the same UI associated with the trigger event (e.g., a customer UI) or another different UI, such as a UI that is viewed by an administrator of the web-based service platform 106. In the example of a product recommendation model, model execution may be triggered via submission of a user search query through a customer UI and the output of the model(s) is rendered to the same customer UI. In the example of a model that analyses help support tickets for particular characteristics, the user may trigger model execution by submitting a help support ticket through a customer UI and the outputs of the model are presented to the UI of a system administrator. Here, the system administrator reviews the model outputs to assess how to direct or resolve the ticket.

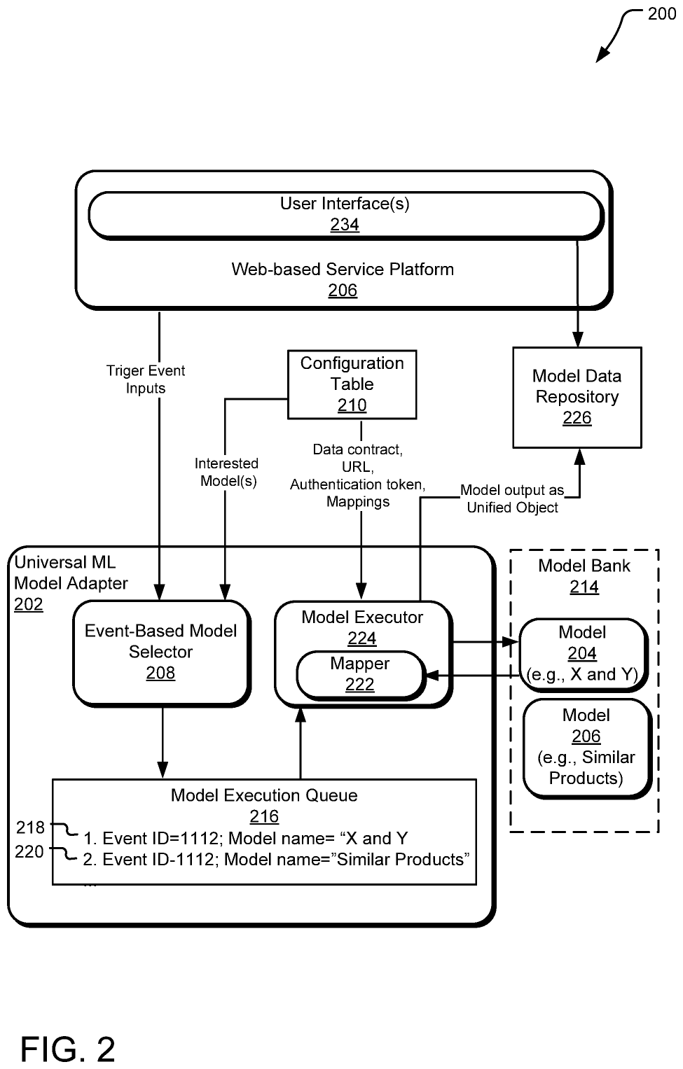

FIG. 2 illustrates another example system 200 including a universal ML model adapter 202 to couple a web-based service platform 206 to multiple different machine learning models (e.g., Model 204, Model 206) in a model bank 214. The web-based service platform 206 defines one or more types of events that are to trigger the provisioning of an associated set of inputs to the universal ML model adapter 202 and, in turn, potentially trigger execution of one or more of the ML models. In one implementation, each of these defined “trigger events” is associated with a particular user that interacts with the web-based service platform 206 through a respective user interface associated with a user account (one of the user interface(s) 234). In some implementations, the trigger event is detected when the user performs a particular type of action, such as clicking on a UI element, submitting a query, etc. In other implementations, the trigger event is detected responsive to some event that occurs independent of user action. If, for example, the web-based service platform 206 supports email or messaging, a trigger event may be detected when the user receives a message or email satisfying set predefined criteria.

When the defined trigger event is detected, a set of inputs is collected and passed to an event-based model selector 208 in the universal ML model adapter 202. The event-based model selector 208 accesses a configuration table 210 and compares the set of inputs to trigger execution criteria that is defined, within the table, in association with each different model in the model bank 214. The event-based model selector 208 identifies a subset of the models in the model bank 214 with trigger execution criteria satisfied by the set of inputs associated with the trigger event. This identified subset of the models in the model bank 214 is referred to in the following description as the “interested models.” According to one implementation, the event-based model selector 208 uses a first application programming interface (API) to query the configuration table 210 and retrieve the trigger execution criteria for each of the models. For example, the first API is accessible to admins of the universal ML model adaptor 202 and contains create, read, update, and delete operations for configuration data stored in the configuration table 210.

For each of the identified interested models,” the event-based model selector 208 creates a queue record in a model execution queue 216. By example, the model execution queue 216 illustrates two different queue records 218 and 220. A first record 218 indicates that a model titled “X and Y” (e.g., products frequently purchased together) is interested in a trigger event having identified by “event ID 1112.” The event ID 1112 uniquely identifies a given trigger event and is, for example, associated in a system table or logfile with a given user ID and the set of inputs passed to the universal ML model adapter 202 in response to detection of the trigger event. A second record 220 in the model execution queue 216 indicates that a second model, titled “Similar Products,” is also interested in the same trigger event with event ID 1112.

A model executor 224 is tasked with sequentially processing each record pending in the record execution queue 216. To process each record, the model executor 224 first queries the configuration table 210 to retrieve information usable to place a call to the model that is identified in the queue record. For the queue record 218, the model executor 224 retrieves a data contract, a URL where the model can be reached, authentication parameters and information for communicating with the URL (if applicable) and mapping information that is usable to map outputs of the model to a unified object. For example, the model executor 224 queries the configuration table 210 for a data contract that is stored in association with the model titled “X and Y.” In one implementation, the model executor 224 additionally retrieves a URL where the model can be reached and authentication parameter(s) usable to generate an authentication token for establishing communications with the URL.

The data contract for the model defines inputs expected by the model and the outputs generated by the model. For example, a model that processes a help support ticket to generate useful inferences may accept as input the text field(s) included in the help ticket; in contrast, a model that recommends products (e.g., X and Y) may accept as input an array of past purchases that of the user (e.g., cookie information stored by the user's web browser). In different implementations, the data used to generate the inputs to each of the interested models is either included within the set of inputs initially passed to the universal ML model adapter 202 (e.g., in response to detection of the associated trigger event) or instead mined, by the universal ML model adapter 202, from an accessible location using information included within the initial set of inputs. For example, the universal ML model adapter 202 is configured to generate the input parameter values for a given one of the interested models based on user account information it mines using an account ID included within the initial set of inputs.

Using the data contract retrieved from the configuration table 210 and the information initially provided to the universal ML model 202 in response to detecting the trigger event, the universal ML model adapter 202 identifies the types of input parameters expected by each interested model and the data source(s) usable to extract or generate each input parameter. The model executor 224 then places an execution call to each of the interested models using the data contract, URL, and an authentication token generated based on the stored authentication parameters (if applicable) that are all retrieved from the configuration table 210. For example, the model executor 224 generates a verification token from authentication parameters stored in the configuration table 210 and places a call to the model 204 by transmitting the authentication token to the URL stored in the configuration table 210 in association with the model identifier for the model 204. The URL responds with a message indicating successful verification of the authentication token, and the model executor 224 then transmits an instruction to execute the model engine on a set of input parameters formed from data captured in association with the trigger event.

In some implementations, the model executor 224 calls the model 204 synchronously, meaning that the model executor 224 waits for a response from the model 204 before proceeding on to a next pending execution task (e.g., the model call and model response are consecutive in a same processing thread). This may be the case if, for example, the model 204 is capable of routinely executing within a predefined time cap, such as a few milliseconds. In the case of synchronous execution of the model 204, the model 204 returns its outputs directly to the model executor 224. In response, the model executor 224 executes a mapper 222 to translate the outputs (e.g., reformat the outputs) of the model 204 into the form of a unified object. The mapper 222 performs this translation using the mapping information retrieved from the configuration table 210.

In other implementations, the model executor 224 calls the model 204 asynchronously, meaning that the task is effectively “handed off” to another processing thread while the model executor 224 proceeds to execute other queued processing tasks. In this scenario, outputs of the model 204 are not automatically provided back to the model executor 224. However, in one implementation, a model 204 is configured (e.g., by its developer) to place a call to the mapper 222 upon completion. In this case, the mapper 222 transforms the model outputs into the form of the unified object in a manner identical to the synchronous execution case.

In different implementations, the unified object may have a variety of different characteristics; however, in one implementation the unified object has properties that include one or more of the name of the associated model, a classification generated based on the model output such as a class that the user has been identified as being a member of, an instruction to a system administrator auto-generated based on the model output (e.g., “please escalate this ticket”), a date and/or time that the model was run, an action button URL (e.g., that redirects the user to further information when interacted with), text for the action button URL (e.g., indicating what action is to occur when user clicks the action button), and/or further descriptive information pertaining to the model results and/or the trigger event.

After translating (reformatting) the outputs of the model 204 into the format of the unified object, the mapper 222 places the unified object into a model data repository 226 which is, for example, a database accessible to the web-based service platform 206 using a second API. For example, the second API includes create, read, update, and delete operations for model data and is accessible to all third-parties executing the models of the model bank 204. The web-based service platform 206 uses this second API to selectively consume each unified object added to the model data repository 226, as is generally described below.

In one implementation, one or more of the user interface(s) 234 execute logic to consume (e.g., self-ingest, interpret, and render) select unified objects residing in the model data repository 226. For example, each of the unified objects includes an identifier (e.g., a user ID or trigger event ID) usable to identify a corresponding user account associated with the trigger event that predicated generation of the unified object. This identifier scheme is used by the user interface(s) 234 to identify and consume unified objects of interest to the associated users.

In one implementation, a user interacts with one of the user interfaces 234 to navigate to a web element (e.g., menu item or webpage) associated with model outputs and a particular user ID or event ID of interest. The web element places an API call to the model executor 224 to retrieve unified object(s) (e.g., generated by various models in association with the particular user ID or event ID) from the model repository 226. In response, the unified object(s) are returned and displayed to the user in an easy-to-understand manner. For example, each different unified object retrieved in association with a particular user or trigger event may be presented the form of a content card that summarizes the outputs of the corresponding ML model.

In one implementation, an event listener (not shown) is executed in association with a given user account on the web-based service platform 206. The event listener monitors the model data repository 226 to identify unified objects satisfying predefined criteria (e.g., unified objects associated with select user account(s)) and further executes logic to render each of the unified objects satisfying the predefined criteria to the UI of the given user account. For example, a help support technician may interact with an event ticketing system through an account that executes an event listener interested in consuming unified objects associated with users residing in a particular geographical location (e.g., unified objects related to help support tickets for all users in North America). Alternatively, a user account with a web-based real estate platform may include an event listener that is interested in consuming unified objects that are generated in association with the user account (e.g., the unified objects relating to price estimation or trend forecasting that are generated based on data supplied by the user of the account).

In the above way, outputs of each of the models are essentially rendered to the interested user(s) of the web-based service platform 206 in real-time. New models can be added to the system 200 without developing code to effectively integrate the model into the existing system. Instead, the integration of a new model into the system 200 can be achieved by way of a configuration update to the configuration table 210 that adds the relevant information for the model (e.g., the model's execution trigger criteria, data contract, URL, parameters for generating an authentication token, and mapping information). Beneficially, this architecture facilities side-by-side testing of similar models with no integration time. For example, a first model can be tested with respect to a first subset of users and a second model can be tested with respect to a second different subset of users. The accuracy of the two models can be compared, such as by implementing a feedback mechanism (e.g., manual administrator review) that provides feedback pertaining to a determined level of accuracy of the data included within each of the unified objects generated by the two models. Accuracy of model results can be evaluated per a variety of readily known and acceptable methods external to the scope of this disclosure.

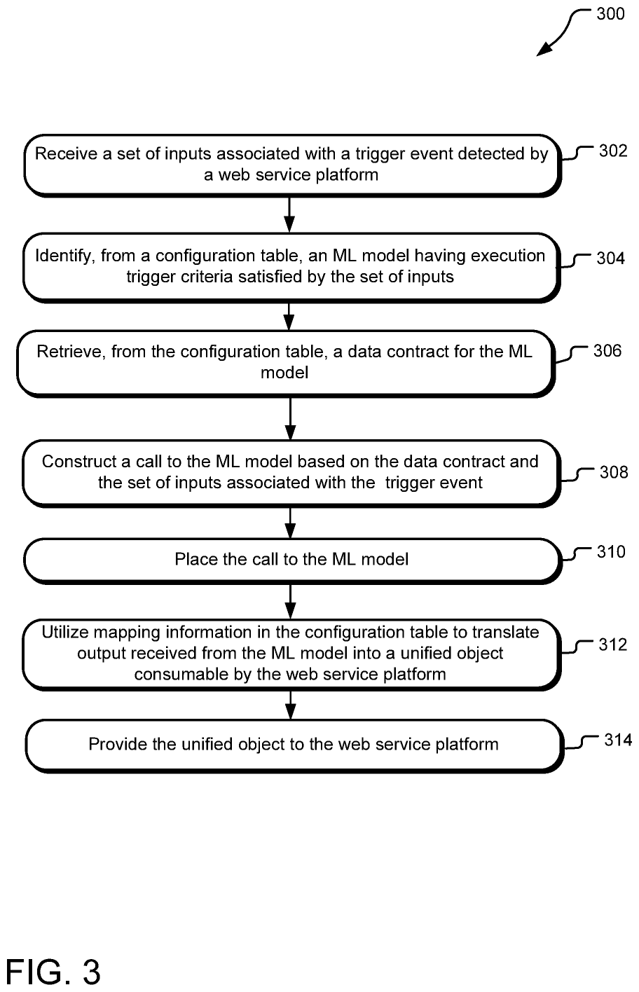

FIG. 3 illustrates example operations 300 for utilizing a universal ML model adapter to support bidirectional data flows between interfaces of a web-based service platform and multiple ML models in real-time without incurring overhead to integrate each newly-selected model into the existing platform. Specific characteristics of the universal ML model adapter not specifically described with respect to FIG. 3 may be the same or similar to those described with respect to other implementations herein.

A receiving operation 302 receives a set of inputs associated with detection of a trigger event. In one implementation, the trigger event is defined by and detected within the web-based service platform. For example, the trigger event is defined as being a user interaction with a UI of the platform that satisfies some predefined criteria (e.g., the user has clicked on a particular element, initiated a query, submitted other input). In response to detecting the trigger event, the set of inputs is identified (e.g., data captured in association with the trigger event) and provided to a universal ML model adapter. In one implementation, the set of inputs includes information suitable to identify a user or user account associated with the trigger event, such as a user account ID, IP address associated with a user account, or other identifying information. The set of inputs may include predefined information captured in association with the trigger event such as cookie information pertaining to a user's current web session, logfiles containing information pertaining to the trigger event, state data pertaining to software or hardware configurations of the user's physical device, user profile data, user account history (e.g., past click history, past purchases, past submissions), and the like.

An identification operation 304 identifies, from a configuration table, at least one ML model having trigger criteria satisfied by the set of inputs. For example, one ML model may have execution trigger criteria satisfied by the type of event (e.g., a type of user interaction with a UI such as a query or submission of a particular input) while another model has execution trigger criteria that is satisfied based on a time of day (e.g., the model is to run on a different set of inputs every 6 hours or once per day).

A retrieving operation 306 retrieves, from a configuration table, a data contract for the ML model. In some implementations, the retrieving operation 306 additionally retrieves other information from the configuration table such as a URL when the model can be reached, authentication parameters for generating an authentication token usable to establish communications with the URL, and/or mapping information for translating outputs of the model to a unified object. A call construction operation 308 constructs a call to the ML model based on the data contract and the set of inputs associated with the trigger event (e.g., the data contract defines the format of input parameters and the set of inputs provides the data values to use as the input parameters).

A call placement operation 310 places the constructed call to the ML model. In some implementations, placing the constructed call to the ML model entails identifying, from the configuration table, a URL where the correspond model engine can be reached and authentication parameters for communicating with the URL. The call is transmitted to the URL, either following authentication of the authentication information or concurrent with an authentication token generated based on the authentication parameters.

A mapping function 312 utilizes mapping information retrieved from the configuration table to translate output received from the ML model into a unified object that is consumable by the web-based service platform, and a providing operation 314 provides the unified object to the web-based service platform such as by placing the unified object in a database accessible to the web-based service platform or to accessible to select UI(s) of the web-based service platform. In one implementation, data if the unified object is automatically rendered to a user interface of the web-based service platform in response to the providing operation 314. In this sense, outputs of the ML model are presented to a user as soon as they become available (in real-time). Due to the use of configuration table as described above, new models can be easily integrated into the web-based service platform by updating the configuration table and without additional code development overhead.

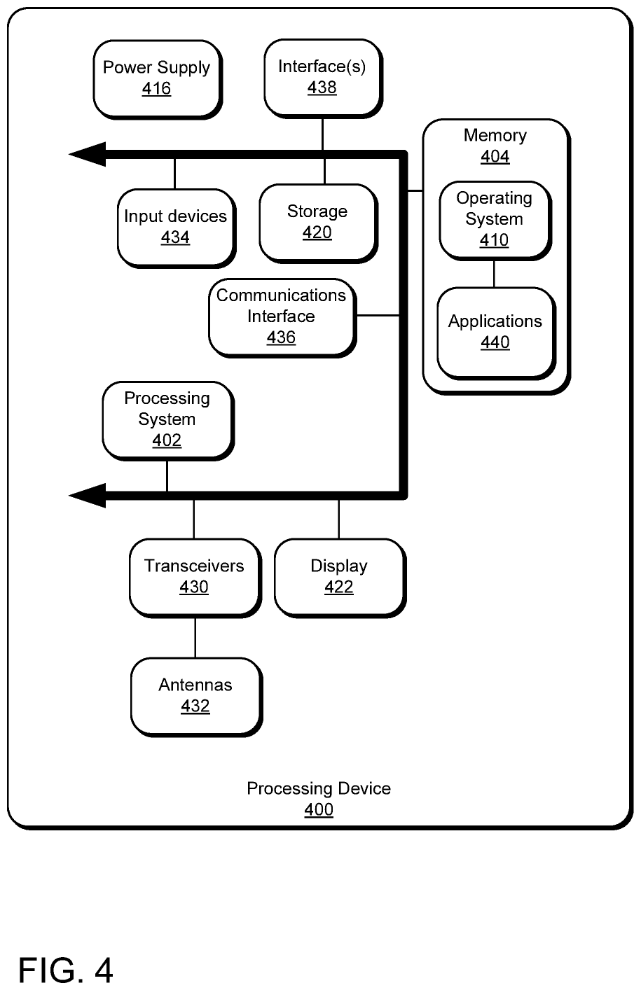

FIG. 4 illustrates an example schematic of a processing device 400 suitable for implementing aspects of the disclosed technology. The processing devices 400 includes one or more processor unit(s) 402, memory device(s) 404, a display 406, and other interfaces 408 (e.g., buttons). The processor unit(s) 402 may each include one or more CPUs, GPUs, etc.

The memory 404 generally includes both volatile memory (e.g., RAM) and non-volatile memory (e.g., flash memory). An operating system 410, such as the Microsoft Windows® operating system, the Microsoft Windows® Phone operating system or a specific operating system designed for a gaming device, may resides in the memory 404 and be executed by the processor unit(s) 402, although it should be understood that other operating systems may be employed.

One or more applications 412 (e.g., all or select components of the universal ML model adapters of FIG. 1 or 2) are loaded in the memory 404 and executed on the operating system 410 by the processor unit(s) 402. The applications 412 may receive inputs from one another as well as from various input local devices such as a microphone 434, input accessory 435 (e.g., keypad, mouse, stylus, touchpad, gamepad, racing wheel, joystick), and a camera 432. Additionally, the applications 412 may receive input from one or more remote devices, such as remotely-located servers or smart devices, by communicating with such devices over a wired or wireless network using more communication transceivers 430 and an antenna 438 to provide network connectivity (e.g., a mobile phone network, Wi-Fi®, Bluetooth®). The processing device 400 may also include one or more storage devices 728 (e.g., non-volatile storage). Other configurations may also be employed.

The processing device 400 further includes a power supply 416, which is powered by one or more batteries or other power sources and which provides power to other components of the processing device 400. The power supply 416 may also be connected to an external power source (not shown) that overrides or recharges the built-in batteries or other power sources.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

An example method selectably executes one of multiple selectable ML models in response to characteristics of a detected trigger event. The method includes receiving, from a web-based service platform, a set of inputs associated with detection of the trigger event and identifying, from a configuration table, an ML model (of multiple ML models represented within the configuration table) that has execution trigger criteria satisfied by the set of inputs. The method further includes retrieving a data contract for the ML model from the configuration table, constructing a call to the ML model based on the data contract, translating output received from the ML model to a unified object consumable by web-based service platform, and providing the unified object to the web-based service platform.

The above method simplifies the task of integrating a new ML model to an existing web-based service platform by utilizing a stored template executable to retrieve parameters from a configuration table in lieu of developing integration code specific to the new model. According to one implementation, the stored table parameters facilitate identification of the type of events that are to trigger execution of the new model, construction of inputs to the model, construction of authentication parameters for establishing communications with the new model, and translation of outputs received from the model into a UI-consumable format.

In another example method of any preceding method, the unified object is of a consistent form regardless of which of the multiple selectable ML models generate the output. This advantageously allows the web service platform to present the outputs of any of the selectable models to a user by placing an API call to retrieve data of the unified object of interest.

In still another example method of any preceding method, the method further includes determining, based on the configuration table, an authentication token for communicating with the ML model and a URL for accessing the ML model, and providing the authentication token to the URL.

In yet still another example method of any preceding method, the trigger event is detected in response to a user interaction with a user interface of the web-based service platform.

In yet still another example method of any preceding method, the method further includes accessing the configuration table using a first application programming interface (API) and placing the unified object in a repository using a second API.

In another method of any preceding method, the ML model executes asynchronously from a processing thread that constructs the call to the ML model. In yet another example method, the ML model executes synchronously with a processing thread that constructs the call to the ML model.

In another example method of any preceding method, the method further includes retrieving, from the configuration table, mapping information for mapping the outputs generated by the ML model to the unified object. In this case, translating the output received from the ML model depends upon the mapping information.

In another aspect, some implementations include a computing system for selectably executing one of multiple selectable ML models in response to characteristics of a detected trigger event. The computing system includes hardware logic circuitry that is configured to perform any of the methods described herein.

In yet another aspect, some implementations include a computer-readable storage medium for storing computer-readable instructions. The computer-readable instructions, when executed by one or more hardware processors, perform any of the methods described herein.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method comprising:
receiving, from a web-based service platform, a set of inputs associated with detection of a trigger event;
identifying, from a configuration table, an ML model having execution trigger criteria satisfied by the set of inputs, the ML model being one of multiple selectable ML models identified in the configuration table;
retrieving, from the configuration table, a data contract for the ML model, the data contract indicating an expected format of inputs to the ML model and an expected format of outputs generated by the ML model;
constructing a call, based on the data contract, to the ML model, the call including input parameter values associated with the trigger event; and
translating, based on the data contract, output received from the ML model to a unified object consumable by web-based service platform; and
providing the unified object to the web-based service platform.

2. The method of claim 1, wherein the unified object is of a consistent form regardless of which of the multiple selectable ML models generate the output.

3. The method of claim 1, further comprising:
determining, based on the configuration table, an authentication token for communicating with the ML model and a URL for accessing the ML model; and
providing the authentication token to the URL.

4. The method of claim 1, wherein the trigger event is detected in response to a user interaction with a user interface of the web-based service platform.

5. The method of claim 3, further comprising:
accessing the configuration table using a first application programming interface (API) and placing the unified object in a repository using a second API, the repository being accessible to one or more user interfaces of the web-based service platform.

6. The method of claim 1, wherein the ML model executes asynchronously from a processing thread that constructs the call to the ML model and wherein translating the output received from the ML model is performed in response to a call initiated by the ML model.

7. The method of claim 1, wherein the ML model executes synchronously with a processing thread that constructs the call to the ML model and wherein translating the output received from the ML model is performed in response to receiving the output from the ML model.

8. The method of claim 1, further comprising:
retrieving, from the configuration table, mapping information for mapping the outputs generated by the ML model to the unified object, wherein translating the output received from the ML model depends upon the mapping information.

9. A system comprising:
a universal machine learning (ML) adapter stored in memory and executable to:
receive, from a web-based service platform, a set of inputs associated with detection of a trigger event;
identify, from a configuration table, an ML model having execution trigger criteria satisfied by the set of inputs, the ML model being one of multiple selectable ML models identified in the configuration table;
retrieve, from the configuration table, a data contract for the ML model, the data contract indicating an expected format of inputs to the ML model and an expected format of outputs generated by the ML model;
construct a call to the ML model based on the data contract, the call including input parameter values associated with the trigger event; and
translate, based on the data contract, output received from the ML model to a unified object consumable by the web-based service platform; and
provide the web-based service platform with the unified object.

10. The system of claim 9, wherein the unified object is of a consistent form regardless of which of the multiple selectable ML models generated the output.

11. The system of claim 9, wherein the universal ML model adapter is further executable to:
retrieve, from the configuration table, an authentication token for communicating with the ML model and a URL for accessing the ML model; and
transmit the authentication token to the URL.

12. The system of claim 9, wherein the trigger event is detected in response to a user interaction with a user interface of the web-based service platform.

13. The system of claim 9, wherein the ML model executes asynchronously from the universal ML model adapter and wherein the universal ML model adapter translates the output received from the ML model in response to a call initiated by the ML model.

14. The system of claim 9, wherein the universal ML model adapter is further executable to:
retrieve, from the configuration table, mapping information for mapping the expected format of outputs generated by the ML model to a format of the unified object, wherein translating the output received from the ML model depends upon the mapping information.

15. A tangible computer-readable storage media encoding computer-executable instructions for executing a computer process, the computer process comprising:
receiving a set of inputs associated with a trigger event;
identifying, from a configuration table, an ML model having execution trigger criteria satisfied by the set of inputs, the ML model being one of multiple selectable ML models identified in the configuration table;
retrieving, from the configuration table, a data contract for the ML model, the data contract indicating an expected format of inputs to the ML model and an expected format of outputs generated by the ML model;
constructing a call, based on the data contract, to the ML model, the call including input parameter values associated with the trigger event; and
translating, based on the data contract, output received from the ML model to a unified object consumable by web-based service platform, the unified object being of a consistent form regardless of which of the multiple selectable ML models generated the output; and
storing the unified object in a repository accessible to the web-based service platform.

16. The tangible computer-readable storage media of claim 15, wherein the computer process further comprises:
determining, based on the configuration table, an authentication token for communicating with the ML model and a URL for accessing the ML model; and
transmitting the authentication token to the URL.

17. The tangible computer-readable storage media of claim 15, wherein the computer process further comprises:
retrieving, from the configuration table, mapping information for mapping the outputs generated by the ML model to the unified object, wherein translating the output received from the ML model depends upon the mapping information.

18. The tangible computer-readable storage media of claim 15, wherein the trigger event is detected in response to a user interaction with a user interface of the web-based service platform and the unified object is automatically rendered to the user interface.

19. The tangible computer-readable storage media of claim 15, wherein the computer process further comprises:
in response to storing the unified object in the repository, automatically rendering the unified object to a user interface of the web-based service platform.

20. The tangible computer-readable storage media of claim 15, wherein the computer process further comprises:
wherein the web-based service platform defines and detects the trigger event.
